(19) United States
(12) Patent Application Publication
(10) Pub. No.: US 2009/0100669 A1
(43) Pub. Date: Apr. 23, 2009

(54) BATTERY MANUFACTURING METHOD AND APPARATUS

(75) Inventors: Kohei IKEDA, Tochigi (JP); Tetsuhiro Takehara, Tochigi (JP); Tomonori Moriwaki, Tochigi (JP); Mitsuhiro Funaki, Tochigi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD, Minato-ku, Tokyo (JP)

(21) Appl. No.: 12/244,274

(22) Filed: Oct. 2, 2008

(30) Foreign Application Priority Data
Oct. 22, 2007 (JP) 2007-274263

(51) Int. Cl. H01M 2/00

(52) U.S. Cl. 29/623.2; 29/731

(57) ABSTRACT

For manufacturing a battery including positive and negative sheet electrodes formed from positive and negative electrode sheets each having active-material-coated portions on opposite surfaces, except for opposite surfaces of one side edge portion, of the sheet and non-active-material-coated portions on the opposite surfaces of the one side edge portion, a method includes: forming a succession of corrugations on each of the sheets, having the coated portions provided thereon, in a longitudinal direction of the sheet; roll-pressing each of the sheets having the corrugations formed thereon; constructing an electrode assembly of the positive and negative sheet electrodes with a separator interposed therebetween; and connecting current collectors to the non-coated portions of the sheet electrodes.

### FIELD OF THE INVENTION

The present invention relates to an improvement in a battery manufacturing method and apparatus.

### BACKGROUND OF THE INVENTION

There have been known batteries including a roll-shaped electrode assembly formed by winding sheet-shaped positive and negative electrodes into a roll shape together with a separator. In manufacturing positive and negative electrodes of these conventionally-known batteries, the positive and negative electrodes would be undesirably deformed due to a difference in extension (or elongation) between a portion coated with an electrode active material and other portions not coated with the electrode active material, as detailed below with reference to FIG. 14 hereof.

FIG. 14 is a view explanatory of a conventionally-known battery manufacturing method. Namely, an electrode sheet 203 having a coated portion 201 coated with an electrode active material 200 and non-coated portions 202 not coated with the electrode active material 200 is roll-pressed to form the coated portion into a predetermined thickness, as shown in (a) of FIG. 14. In this condition, the non-coated portions 202 of the electrode sheet 203 are each flat and has no plastic deformation as viewed in its section along the a-a line in the figure (see (b) of FIG. 14), while the coated portion 201 has plastic deformation and resultant extension as viewed in its section along the b-b line (see (c) of FIG. 14). If the electrode sheet 203 is cut in its longitudinal direction centrally through the width of the sheet 203, positive electrodes 205 (or negative electrodes 206) formed by the cutting would each curve in the widthwise direction to take a shape similar to a sector shape. The c-c line in the figure indicates a section of the non-coated portion (i.e., non-active-material-coated portion) 202 (see a sectional view in (e) of FIG. 14), and the d-d line indicates a section of the coated portion (i.e., active-material-coated portion) 201 (see a sectional view in (f) of FIG. 14). Battery manufacturing method intended to prevent such electrode deformation is known, for example, from Japanese Patent Application Laid-Open Publication No. 2001-357840.

FIG. 15 is a view showing an electrode sheet manufacturing apparatus disclosed in the 2001-357840 publication. The disclosed electrode sheet manufacturing apparatus includes: a paying-out mechanism 211 for paying out a leading section of the electrode sheet 211 having an active-material-coated portion; a bending processing mechanism 213 for bending a non-active-material-coated portion of the leading section of the of the electrode sheet 211 into a corrugated wave shape through plastic deformation; a pair of tension imparting mechanisms 214 and 216 for roll-pressing the corrugated portion of the electrode sheet 211 while imparting tension to the corrugated portion; and a cutting mechanism 217 for cutting the roll-pressed portion of the leading section of the electrode sheet 211.

However, because not only the non-active-material-coated portion of the electrode sheet 211 is extended due to the corrugation process but also the active-material-coated portion too is extended due to the roll-pressing, the entire paid-out leading section of the electrode sheet 211 is considerably extended in the longitudinal direction of the electrode sheet 211. Thus, the paid-out section of the electrode sheet 211 has an excessively reduced thickness and hence a reduced strength against a pulling force. Consequently, at a stage following the cutting step, the positive-pole and negative-pole electrode sheets may break and/or be further extended when wound into a roll shape together with a separator.

Further, in some conventional electrode sheet manufacturing apparatus, pressing, slitting and winding steps of an electrode sheet process edges of the electrode sheet, and thus, if the edges of the electrode sheet has a corrugated shape, it tends to be difficult to accurately position the electrode sheet at a predetermined position, which results in a reduced processing accuracy.

### SUMMARY OF THE INVENTION

In view of the foregoing prior art problems, it is an object of the present invention to provide an improved battery manufacturing method and apparatus which not only can minimize an undesired thickness change of electrode sheets but also can minimize lowering of a processing accuracy of the electrode sheets.

In order to accomplish the above-mentioned object, the present invention provides an improved method for manufacturing a battery including positive and negative sheet electrodes formed from positive and negative electrode sheets each having active-material-coated portions on opposite surfaces, except for opposite surfaces of one side edge portion, of the electrode sheet and non-active-material-coated portions on the opposite surfaces of the one side edge portion of the electrode sheet, which comprises: a step of forming a succession of corrugations on each of the positive and negative electrode sheets, having the active-material-coated portions provided thereon, in a longitudinal direction of the electrode sheet; a step of roll-pressing each of the positive and negative electrode sheets having the succession of corrugations formed thereon; a step of constructing an electrode assembly of the positive and negative sheet electrodes, formed from the roll-pressed positive and negative electrode sheets respectively, with a separator interposed therebetween; a step of connecting positive and negative current collectors to the non-coated portions of the positive and negative sheet electrodes, respectively, exposed on ends of the electrode assembly; and a step of enclosing the electrode assembly and the positive and negative current collectors in a case together with battery electrolyte.

In the roll-pressing step, only the active-material-coated portions (i.e., electrode active material and electrode film) are roll-pressed. Namely, the active-material-coated portions of the electrode sheet (i.e., of a leading section of the electrode sheet) are roll-pressed and extended, while the non-active-material-coated portions of the electrode sheet are not roll-pressed and extended because they have a smaller thickness than the active-material-coated portions.

With the arrangement that the electrode sheet is roll-pressed after the formation, in the longitudinal direction, of the succession of corrugations, the extension produced in the active-material-coated portions of the electrode film due to the roll-pressing can be effectively absorbed in the corrugations, so that no residual stress arises from a difference in extension between the active-material-coated portions and the non-active-material-coated portions of the electrode sheet; thus, the electrode sheet will not curve when it is cut in the longitudinal direction thereof through the width of the sheet. Because almost no extension occurs in the non-active-material-coated portions of the electrode sheet, a thickness change of the electrode sheet can be minimized or prevented. Further, because the battery manufacturing method of the present invention is not arranged to process the side edges of the electrode sheet, it can effectively prevent reduction or lowering of processing accuracy. As a result, it is possible to prevent unwanted breakage and further extension of the positive and negative sheet electrodes when constructing the electrode assembly, and thus achieve an enhanced productivity and product quality of the battery.

In an embodiment, the above-mentioned step of forming a succession of corrugations forms the corrugations on each of the positive and negative electrode sheets by imparting tension to portions of the electrode sheet located upstream and downstream of roll-pressing rollers when the electrode sheet is to be roll-pressed via the rollers. Namely, as the electrode sheet is fed forward through the rollers, the electrode sheet is pulled forwardly, i.e., downstream, of the rollers. Because the non-active-material-coated portions, having a smaller thickness than the active-material-coated portions, are not sandwiched and detained by the roll-pressing rollers with only the active-material-coated portions sandwiched and detained by the roll-pressing rollers, only the non-active-material-coated portions are moved forward in a sheet feeding direction, so that a succession of corrugations can be produced in the electrode sheet. Thus, the method of the invention can form the corrugations with ease by just imparting tension to the electrode sheet.

In one embodiment, the step of forming a succession of corrugations forms the corrugations on each of the positive and negative electrode sheets by plastically deforming the active-material-coated portions of the electrode sheet. Such plastically deformation allows the succession of corrugations to be formed with increased ease and accuracy.

In one embodiment, the step of forming a succession of corrugations forms the corrugations on each of the positive and negative electrode sheets after heating the active-material-coated portions of the electrode sheet. Such heating allows the active-material-coated portions (i.e., electrode active material and electrode film) to be plastically deformed easily, which can even further facilitate the formation of the corrugations.

The present invention can be implemented as an apparatus invention as well as the method invention as discussed above. Namely, the present invention provides an improved apparatus for manufacturing a battery including positive and negative sheet electrodes formed from positive and negative electrode sheets each having active-material-coated portions on opposite surfaces, except for opposite surfaces of one side edge portion, of the electrode sheet and non-active-material-coated portions on the opposite surfaces of the one side edge portion of the electrode sheet, which comprises: a section for forming a succession of corrugations on each of the positive and negative electrode sheets, having the active-material-coated portions provided thereon, in a longitudinal direction of the electrode sheet; and a section for roll-pressing each of the positive and negative electrode sheets having the corrugations formed thereon, an electrode assembly being constructed of the positive and negative sheet electrodes with a separator interposed therebetween, the electrode assembly and the positive and negative current collectors, connected to the non-active-material-coated portions of the positive and negative sheet electrodes exposed on opposite ends of the electrode assembly, being enclosed in a case together with battery electrolyte.

In the roll-pressing section, only the active-material-coated portions (i.e., electrode active material and electrode film) are roll-pressed. Namely, the active-material-coated portions of the electrode sheet are roll-pressed and extended, while the non-active-material-coated portions of the electrode sheet are not roll-pressed and extended because they have a smaller thickness than the active-material-coated portions. With the arrangement that the electrode sheet is roll-pressed after the formation, in the longitudinal direction, of the succession of corrugations, the extension produced in the active-material-coated portions of the electrode film due to the roll-pressing can be absorbed in the corrugations, so that no residual stress arises from a difference in extension between the active-material-coated portions and the non-active-material-coated portions of the electrode sheet; thus, the electrode sheet will not curve, due to a difference in extension between the active-material-coated portions and the non-active-material-coated portions, when it is cut in the longitudinal direction thereof through the width of the sheet. Because almost no extension occurs in the non-active-material-coated portions of the electrode sheet, the thickness change of the electrode sheet, particularly the non-active-material-coated portions, can be minimized. Further, because the battery manufacturing apparatus of the invention is not arranged to process the side edges of the electrode sheet, it can effectively prevent reduction or lowering of processing accuracy. As a result, it is possible to prevent unwanted breakage and further extension of the positive and negative sheet electrodes when constructing the electrode assembly, and thus achieve an enhanced productivity and product quality of the battery.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will be described in detail below, by way of example only, with reference to the accompanying drawings, in which:

FIG. 1 is a sectional view showing a battery manufactured in accordance with the present invention;

FIG. 2 is an exploded perspective view of the battery of FIG. 1;

FIG. 3 illustrates positive and negative sheet electrodes employed in the battery of FIG. 1;

FIG. 4 is a view illustrating a sheet electrode manufacturing apparatus according to a first embodiment of the present invention;

FIGS. 5A-5D are views explanatory of a basic principle on the basis of which the sheet electrode is plastically deformed in the embodiment of the present invention;

FIG. 6 is a view explanatory of a second embodiment of the sheet electrode manufacturing apparatus of the present invention;

FIG. 7 is a side view explanatory of a third embodiment of the sheet electrode manufacturing apparatus of the present invention;

FIG. 8 is a side view explanatory of a fourth embodiment of the sheet electrode manufacturing apparatus of the present invention;

FIG. 9 is a side view explanatory of a fifth embodiment of the sheet electrode manufacturing apparatus of the present invention;

FIG. 10 is a side view explanatory of a sixth embodiment of the sheet electrode manufacturing apparatus of the present invention;

FIG. 11 is a side view explanatory of a seventh embodiment of the sheet electrode manufacturing apparatus of the present invention;

FIG. 12 is a side view explanatory of an eighth embodiment of the sheet electrode manufacturing apparatus of the present invention; and

FIG. 13 is a side view explanatory of a ninth embodiment of the sheet electrode manufacturing apparatus of the present invention;

FIG. 14 is a view explanatory of a conventionally-known battery electrode manufacturing method; and

FIG. 15 is a view explanatory of a conventionally-known battery manufacturing apparatus.

### DETAILED DESCRIPTION OF THE PREFERRED EMBODIMENTS

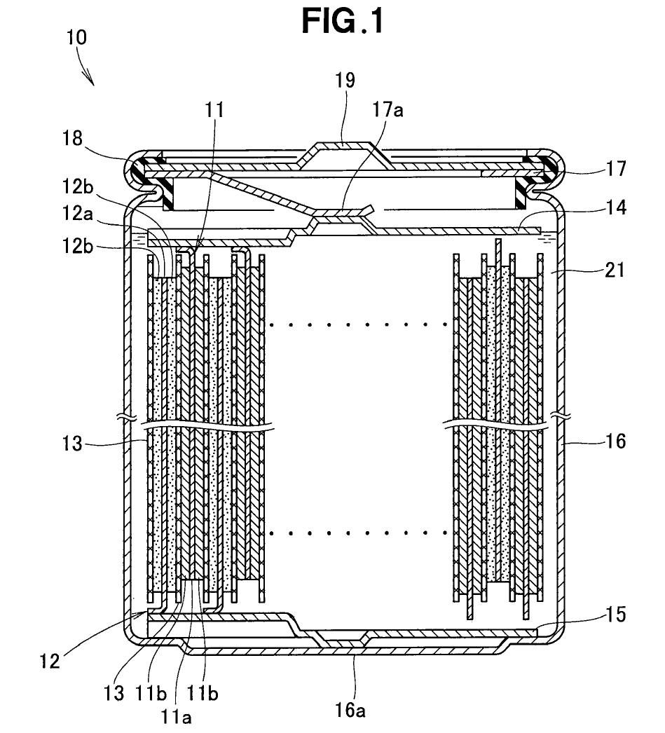

Reference is now made to FIG. 1 showing in section a battery manufactured in accordance with the present invention. The battery 10 includes: positive and negative sheet electrodes 11 and 12 each having its opposite surfaces coated with an electrode active material; separators 13 disposed between the positive and negative sheet electrodes 11 and 12 etc.; a current collector 14 held in contact with an upper end portion (i.e., non-active-material-coated portion) of the positive sheet electrode 11; a current collector 15 held in contact with a lower end portion (i.e., non-active-material-coated portion) of the negative sheet electrode 12; a conductive case 16 having accommodated therein the positive and negative sheet electrodes 11 and 12, separators 13 and disk-shaped current collector 14 and 15; a conductive plate 17 pressing the positive and negative sheet electrodes 11 and 12, separators 13 and current collector 14 and 15 against the bottom of the case 16; a lid 19 swaged, via a gasket 18, to an opening portion of the case 16 together with the conductive plate 17; and battery electrolyte 21 accommodated in the case 16.

The positive sheet electrode 11 comprises a positive electrode film 11a and active material 11b coated on the opposite surfaces of the positive pole film 11a. The negative sheet electrode 12 comprises a negative electrode film 12a and active material 12b coated on the opposite surfaces of the negative pole film 11b.

The separators 13 electrically insulate between the positive sheet electrode 11 and the negative sheet electrode 12 and between the negative sheet pole 12 and the case 16. The current collectors 14 and 15, which are identical in construction and behavior to each other, are incorporated in the case 16 in vertically opposite orientations, and they are indicated by different reference characters in the figures for convenience of description.

The negative sheet electrode 12 may be held in direct contact with the case 16 without the current collector 15 being used. The conductive plate 17 has a pressing section 17a that provides a pressing force by being flexed at the time of assembly.

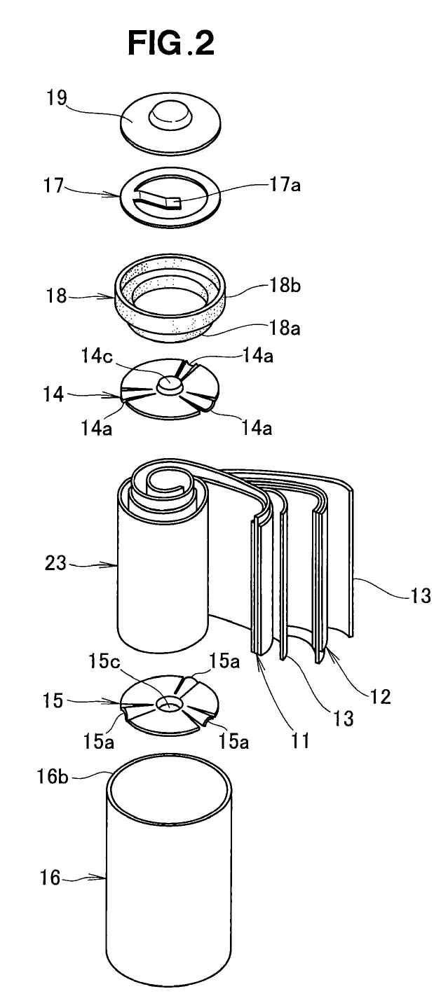

FIG. 2 is an exploded perspective view of the battery 10. The battery 10 is made by sequentially inserting, in the case 16, the disk-shaped current collector 15, an electrode assembly 23 comprising rolls of the separator 13 superposed on the outside of the positive sheet electrode 11, the negative sheet electrode 12 superposed on the outside of the separator 13 and the separator 13 superposed on the outside of the negative sheet electrode 12, and the disk-shaped current collector 14. The gasket 18 has a small-diameter section 18a inserted in an upper-end opening portion 16b of the case 16, and the conductive plate 17 and lid 19 are inserted in a large-diameter section 18b of the gasket 18.

After the conductive plate 17 and lid 19 are inserted in the opening portion 16b of the case 16, the upper end portion of the case 16 is sealed by being squeezed radially inwardly as shown in FIG. 1.

Each of the current collectors 14 and 15 has a plurality of radial protrusions 14a or 15a and a central protrusion 14c or 15c. The central protrusion 14a of the current collector 14 is a section that connects to the pressing section 17a of the conductive plate 17, while the central protrusion 15c of the current collector 15 is a section that connects to the bottom 16a (see FIG. 1) of the case 16. The case 16 has its outer surface electrically insulated, except for the bottom 16a.

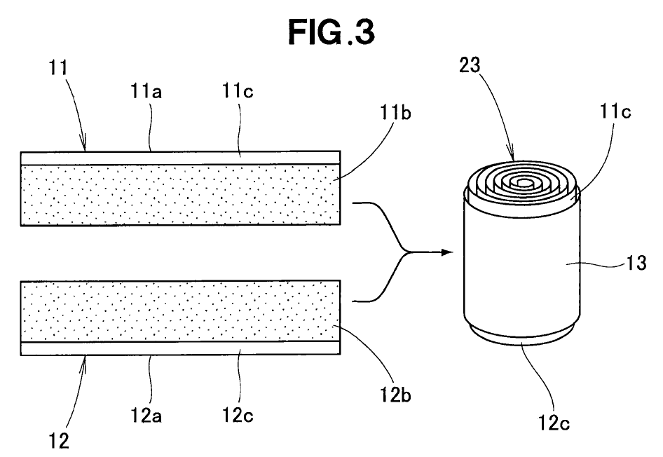

FIG. 3 is a view explanatory of the positive and negative sheet electrodes employed in the embodiment of the present invention. The positive electrode film 11a of the positive sheet electrode 11 has the opposite surfaces coated with the electrode active material 11b (to provide “active-material-coated portions” or “coated portions”, which are also indicated by reference characters 11b), except for one side edge portion of the film 11a; the coated portion 11b of the inner (reverse) surface is not visible the figure. In the illustrated example, “non-active-material-coated portions” or “non-coated portions” 11c (the non-coated portion 11c of the inner (reverse) surface is not visible in the figure) are each formed on the upper side of the positive sheet electrode 11 and have a predetermined width.

The negative electrode film 12a of the negative sheet electrode 12 has the opposite surfaces coated with the electrode active material 12b (to provide active-material-coated portions or coated portions, which are also indicated by reference characters 12b), except for one side edge portion of the film 12a; the coated portion 12b of the inner (reverse) surface is not visible the figure. In the illustrated example, the non-coated portions 12c (the non-coated portion 12c of the inner (reverse) surface is not visible in the figure) are each formed on the lower side of the negative sheet electrode 12 and have a predetermined width. The non-coated portions (i.e., non-active-material-coated portion) 11c and 12c have higher electrical conductivity than the coated portions 11b and 12b.

These positive and negative sheet electrodes 11 and 12 are wound into a roll shape with the separator 13 interposed therebetween in such a manner that the active materials 11b and 12b superposed on each other via the separator 13, and then accommodated in the case 16 with the non-coated portions 11c and 12c exposed or projecting outwardly beyond the opposite ends of the roll-shaped electrode assembly 23 (see FIG. 2).

The following paragraphs describe an apparatus and method for manufacturing the above-described positive and negative sheet electrodes 11 and 12 in accordance with embodiments of the present invention.

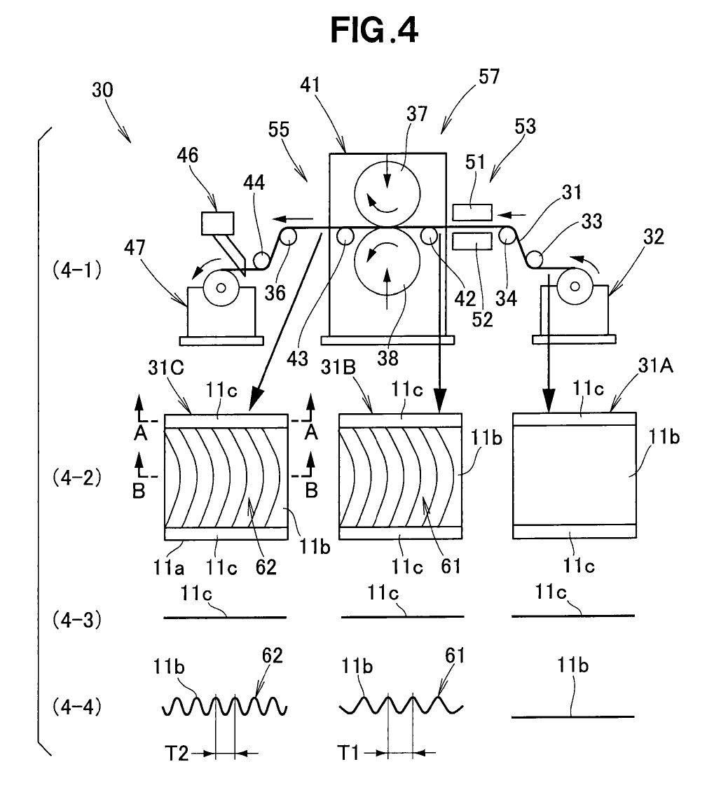

FIG. 4 is a view explanatory of a first embodiment of the sheet electrode manufacturing apparatus of the present invention. As shown in (4-1) of FIG. 4, the sheet electrode manufacturing apparatus 30 includes: a paying-out device 32 for reeling out or paying out a leading section of an electrode sheet 31 having its opposite surfaces coated with the electrode active material; an idle roller 33 for changing a feeding direction of the leading section of the electrode sheet 31; an input-side driving roller 34 and output-side driving roller 36 for imparting a feed force to the leading section of the electrode sheet 31; a pair of roll-pressing rollers 37 and 38 disposed between the input-side and output-side driving rollers 34 and 36 to roll-press the active material coated on the opposite surfaces (i.e., active-material-coated portions) of the leading section of sheet 31 into a predetermined thickness; a roll device 41 for driving the roll-pressing rollers 37 and 38 to produce a sheet pressing force; auxiliary rollers 42 and 43 disposed at opposite sides (i.e., upstream and downstream) of the roll-pressing rollers 37 and 38 for secondarily supporting the leading section of the electrode sheet 31; an idle roller 44 for changing the feeding direction of the leading section of the electrode sheet 31; a cutting mechanism 46 for cutting the leading section of the electrode sheet 31 in the longitudinal direction centrally through the width of the sheet 31, to provide two electrode sheets; a taking-up device 47 for rewinding or taking up the two electrode sheets made by the cutting of the leading section of the electrode sheet 31; and an induction heating device 53 disposed between the input-side driving roller 34 and the roll-pressing rollers 37 and 38 and including a pair of induction coils 51 and 52 disposed so as to sandwich therebetween the leading section of the electrode sheet 31 at a position upstream of the roll-pressing rollers 37 and 38.

The input-side driving roller 34 and output-side driving roller 36 differ from each other in rotating speed; namely, the output-side driving roller 36 is caused to rotate at a slightly higher speed than the input-side driving roller 34, to thereby impart predetermined tension to a portion of the electrode sheet 31 located between the roll-pressing rollers 37 and 38 and the output-side driving roller 36. That is, the input-side driving roller 34 and output-side driving roller 36 together constitute a tension imparting device 55.

Further, the roll-pressing rollers 37 and 38 rotate at the same speed as the input-side driving roller 34; thus, during the roll-pressing of the electrode sheet 31 by the roll-pressing rollers 37 and 38, a portion of the electrode sheet 31 located between the output-side driving roller 36 and the roll-pressing rollers 37 and 38 has greater tension than a portion of the electrode sheet 31 located between the input-side driving roller 34 and the roll-pressing rollers 37 and 38. The roll-pressing rollers 37 and 38 and the roll device 41 together constitute a rolling device 57.

The induction heating device 53 induces a voltage in the leading section of the electrode sheet 31, by means of the induction coils 51 and 52, to produce a heating current flow in the leading section of the electrode sheet 31. The leading section of the electrode sheet 31 is heated by Joule heat produced through electric resistance of the sheet 31. As the leading section of the electrode sheet 31 is heated by the induction heating device 53, it gets easier to plastically deform.

Next, behavior of the electrode manufacturing apparatus 30 will be explained to describe an example manner or method in which the electrode sheet 31 is manufactured in accordance with the basic principles of the present invention. Although how the positive sheet electrode 11 is manufactured will be primarily or representatively described hereinbelow, it should be appreciated that the negative sheet electrode 12 is manufactured in the same manner as the positive sheet electrode 11.

The leading section of the electrode sheet 31 is first paid out from the paying-out device 32, then imparted with tension by the input-side driving roller 34 and output-side driving roller 36 (rolling at different speeds), and then pressed between and rolled by the roll-pressing rollers 37 and 38 rotating while the induction heating device 53 is heating the leading section of the electrode sheet 31. The leading section of the electrode sheet 31 roll-pressed by the roll-pressing rollers 37 and 38 are divided into two electrode sheets by being cut by the cutting device 46 centrally through the width of the electrode sheet 31, and then the thus-made two electrode sheets are taken up by the taking-up device 47.

(4-2) of FIG. 4 shows plan views of the leading section of the electrode sheet 31 in various manufacturing stages or steps, (4-3) of FIG. 4 shows sectional views of the non-coated portion (i.e., non-active-material-coated portion) 11c taken along the A-A line of the corresponding plan views in (4-2), and (4-4) of FIG. 4 shows sectional views of the coated portion (i.e., active-material-coated portion) 11b taken along the B-B line of the corresponding plan views.

Before passing the input-side driving roller 34, each of the coated and non-coated portions 11b and 11c in the leading section 31A of the electrode sheet 31 has not been plastically deformed.

On the leading section 31B (which is identical to the leading section 31A but indicated by the different reference character 31B to facilitate understanding) of the electrode sheet 31 located between the input-side driving roller 34 and the roll-pressing rollers 37 and 38, corrugations 61 have been produced by the tension imparted by the input-side driving roller 34 and output-side driving roller 36. Such corrugations 61 are produced on only the coated portions 10b or on both of the coated portions 10b and non-coated portions 11c. The following lines describe the case where the corrugations 61 have been produced only on the coated portions 10b.

On the leading section 31C (which is identical to the leading section 31A but indicated by the different reference character 31C to facilitate understanding) of the electrode sheet 31 located between the roll-pressing rollers 37 and 38 and the output-side driving roller 36, other corrugations 62 have been produced by the tension imparted by the input-side driving roller 34 and output-side driving roller 36 and by plastic deformation (extension) of the coated portions 10b (active material and positive electrode film 11a) resulting from the roll-pressing by the roll-pressing rollers 37 and 38. No plastic deformation has been produced in the non-coated portions 11c.

The corrugations 62 have a shorter waveform cycle than the corrugations 61 because it is a combination of the corrugations 61 and the extension resulting from the roll-pressing by the roll-pressing rollers 37 and 38 (namely, the extension has been absorbed in the corrugations 61). If the waveform cycle of the corrugations 61 is indicated by T1 and the waveform cycle of the corrugations 62 is indicated by T2, T2<T1.

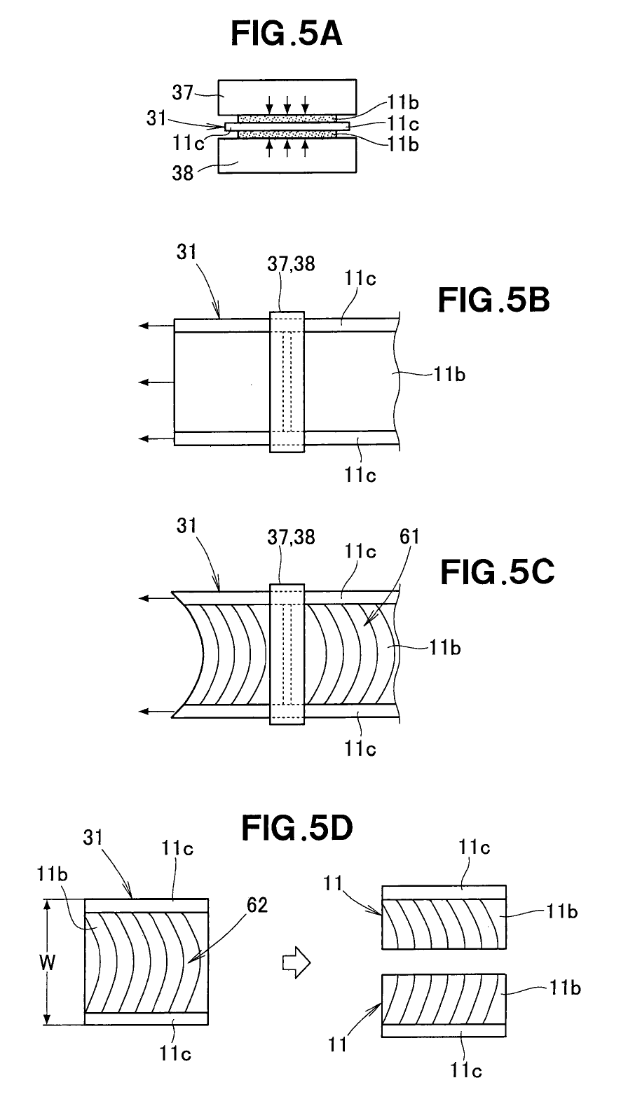

FIGS. 5A-5D are views explanatory of a principle on the basis of which the plastic deformation of the leading section of the electrode sheet 31 occurs. While the leading section of the electrode sheet 31 is being roll-pressed by the roll-pressing rollers 37 and 38, as shown in FIG. 5A, the non-coated portions 11c are not in contact with the roll-pressing rollers 37 and 38 because they have a smaller thickness than the coated portions 11b.

As shown in FIG. 5B, the coated portions 11b (provided on the opposite surfaces of the sheet 31) each contact the roll-pressing rollers 37 and 38 in a straight line. Thus, even if the tension is imparted to the leading section of the electrode sheet 31, the coated portions 11b do not move in the feeding direction because they are detained by the roll-pressing rollers 37 and 38.

Further, because the non-coated portions 11c are not detained by the roll-pressing rollers 37 and 38, only the non-coated portions 11c are moved forward in the sheet feeding direction as shown in FIG. 5C, corrugations 61, curved convexly in an opposite direction from the feeding direction as viewed in plan, are produced in the leading section of the electrode sheet 31 prior to the roll-pressing by the roll-pressing rollers 37 and 38. Such corrugations 61 are also produced on a portion of the leading section of the electrode sheet 31 located downstream of the roll-pressing rollers 37 and 38.

FIG. 5D shows two positive sheet electrodes 11 having been formed by the leading section of the electrode sheet 31 being cut in the longitudinal direction centrally through the width W of the electrode sheet 31 after the roll-pressing by the rollers 37 and 38.

Namely, as set forth above in relation to FIGS. 1, 3, 4 and FIGS. 5A-5D, the present invention provides the battery manufacturing method of the type which first forms the positive sheet electrode 11 and negative sheet electrode 12 by providing the coated portions (active-material-coated portions) 11b and 12b on the opposite surfaces, except for those of respective one side edge portions, of the positive electrode sheet and negative electrode sheet and providing the non-coated portions (non-active-material-coated portions) 11c and 12c on the opposite surfaces of the respective one side edge portions of the electrode sheets, then constructs the electrode assembly 23 of the positive and negative sheet electrodes 11 and 12 with the separator 13 interposed therebetween, and then connects the positive and negative current collectors 14 and 15 to the non-coated portions 11c and 12c exposed on the opposite ends of the electrode assembly 23. As novel features of the battery manufacturing method of the invention, a succession of the corrugations 61 is formed on the electrode sheet 31, having the coated portions 11b, 12b provided thereon, in the longitudinal direction of the electrode sheet 31. Then, the electrode sheet 31, having the corrugations 61 formed thereon, is roll-pressed, and the thus roll-pressed electrode sheet 31 is cut in the longitudinal direction centrally through its width W, to provide two positive or negative sheet electrodes 11 or 12. With the feature that the electrode sheet 31 is roll-pressed after the succession of the corrugations 61 has been formed on the leading section of the electrode sheet 31 in the longitudinal direction of the sheet 31 as noted above, extension of the coated portions 11b or 12b produced by the roll-pressing can be absorbed in the corrugations 61. Thus, it is possible to not only prevent unwanted curvature, in the width direction, of each of the positive and negative sheet electrodes 11 and 12 produced due to a difference in extension between the coated portions 11b, 12b and the non-coated portions 11c, 12c when the roll-pressed electrode sheet 31 has been cut in the longitudinal direction centrally through its width W, but also minimize a change in the thickness of the electrode sheet 31, particularly the non-coated portions 11c, 12c.

Furthermore, because the battery manufacturing method of the invention is not arranged to process the edges of the electrode sheet 31, it can effectively prevent reduction in the processing accuracy. As a consequence, it is possible to prevent unwanted breakage and further extension of the positive and negative sheet electrodes 11 and 12 when constructing the electrode assembly 23 and thus achieve an enhanced productivity and product quality of the battery 10.

Further, prior to the roll-pressing of the electrode sheet 31, portions of the electrode sheet 31 located upstream and downstream of the roll-pressers 37 and 38 are imparted with tension, to thereby form the corrugations 61 on the electrode sheet 31. Thus, the corrugations 61 can be formed easily by the imparted tension.

Further, because the corrugations are formed after the coated portions 11b and 12b are heated, the corrugation formation can be even further facilitated because the heating of the coated portions 11b and 12b allows the electrode sheet 31 to be plastically deformed more easily.

The present invention also provides the battery manufacturing apparatus of the type which first forms the positive sheet electrode 11 and negative sheet electrode 12 by providing the coated portions 11b and 12b on the opposite surfaces, except for those of respective one side edge portions, of the positive electrode sheet and negative electrode sheet and providing the non-coated portions 11c and 12c on the opposite surfaces of the respective one side edge portions of the electrode sheets, then constructs the electrode assembly 23 of the positive and negative sheet electrodes 11 and 12 with the separator 13 interposed therebetween, and then connects the positive and negative current collectors 14 and 15 to the coated portions 11c and 12c exposed on the opposite ends of the electrode assembly 23. As novel features of the battery manufacturing apparatus of the present invention, the apparatus includes: the tension imparting device 55 for forming a succession of corrugations 61 on the leading section of the electrode sheet 31 in the longitudinal direction of the sheet 31 having the coated portions 11b, 12b; the roll-pressing device 57 for roll-pressing the electrode sheet 31 having the corrugations 61 formed thereon; and the cutting device 46 for cutting the thus roll-pressed electrode sheet 31 in the longitudinal direction centrally through its width W, to provide two positive or negative sheet electrodes 11 or 12. The electrode assembly 23 and the positive and negative current collectors 14 and 15 are inserted, together with the electrolyte 21, into the case 16, after which the case 16 is sealed. With the feature that the electrode sheet 31 is roll-pressed after the succession of the corrugations 61 has been formed on the leading section of the electrode sheet 31 in the longitudinal direction of the sheet 31 as noted above, extension of the coated portions 11b, 12b produced by the roll-pressing can be absorbed in the succession of the corrugations 61. Thus, it is possible to not only prevent unwanted curvature, in the width direction, of each of the positive and negative sheet electrodes 11 and 12 produced due to a difference in extension between the coated portions 11b, 12b and the non-coated portions 11c, 12c when the roll-pressed electrode sheet 31 has been cut in the longitudinal direction centrally through its width W, but also minimize a change in the thickness of the electrode sheet 31, particularly the non-coated portions 11c, 12c.

Furthermore, because the battery manufacturing apparatus of the invention does not process the edges of the electrode sheet 31, it can effectively prevent reduction in the processing accuracy. As a consequence, it is possible to prevent unwanted breakage and further extension of the positive and negative sheet electrodes 11 and 12 when constructing the electrode assembly 23 and thus achieve an enhanced productivity and product quality of the battery 10.

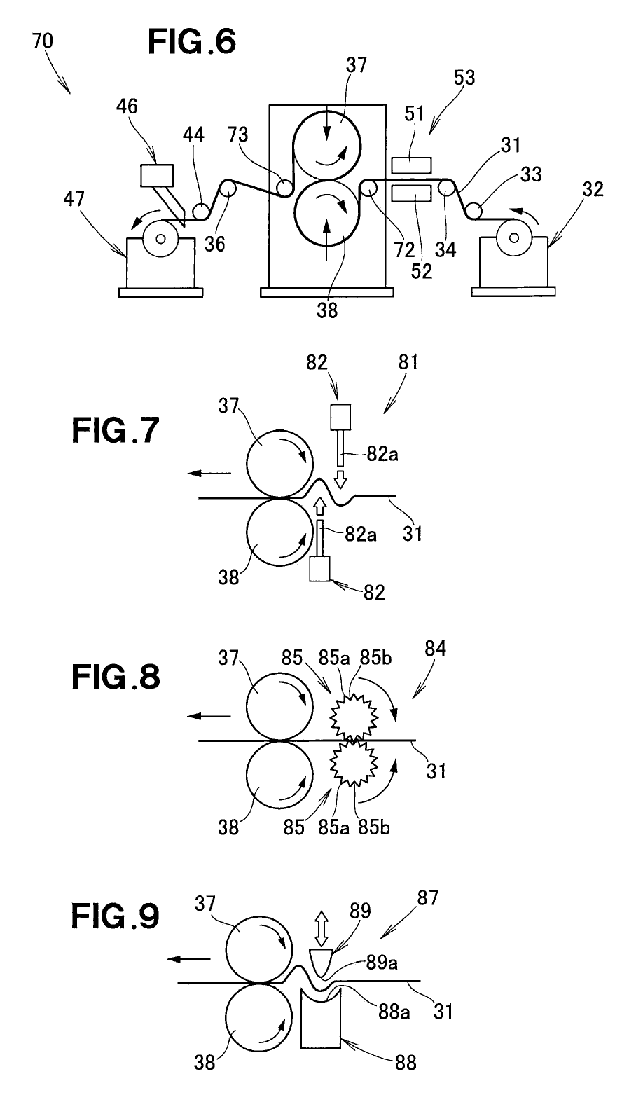

FIG. 6 is a view explanatory of a second embodiment of the sheet electrode manufacturing apparatus of the present invention. The second embodiment of the sheet electrode manufacturing apparatus 70 is similar to the above-described first embodiment of the sheet electrode manufacturing apparatus 30 of FIG. 4, except that the auxiliary rollers 42 and 43 of FIG. 4 are replaced with idle rollers 72 and 73.

In the sheet electrode manufacturing apparatus 70, the feeding direction of the leading section of the electrode sheet 31 is changed via the idle roller 72, located upstream of the roll-pressing rollers 37 and 38, so that the leading section is wound around the roll-pressing rollers 37 and 38 in an inverted S shape. The feeding direction of the leading section of the electrode sheet 31 is further changed via the idle roller 73 located downstream of the roll-pressing rollers 37 and 38. The formation of the corrugations 61 and 62 is performed in the sheet electrode manufacturing apparatus 70 in generally the same manner as in the sheet electrode manufacturing apparatus 30 of FIG. 4.

FIG. 7 is a side view explanatory of a third embodiment of the sheet electrode manufacturing apparatus of the present invention. In the third embodiment of the sheet electrode manufacturing apparatus, a corrugation forming mechanism 81 comprises a pair of air jetting devices 82 that are disposed so as to sandwich therebetween the leading section of the electrode sheet 31 and that are offset from each other in the feeding direction of the electrode sheet 31. These air jetting devices 82 jet air from their respective air jet orifices 82a toward the leading section of the electrode sheet 31 being fed forward, to thereby form corrugations on the leading section of the electrode sheet 31.

FIG. 8 is a side view explanatory of a fourth embodiment of the sheet electrode manufacturing apparatus of the present invention. In the fourth embodiment of the sheet electrode manufacturing apparatus, a corrugation forming mechanism 84 comprises a pair of corrugation forming dies 85 that are disposed so as to sandwich therebetween the leading section of the electrode sheet 31. Each of the corrugation forming dies 85 has alternating ridges and furrows 85a and 85b. These corrugation forming dies 85 form corrugations on the leading section of the electrode sheet 31 by rotating with the leading section sandwiched therebetween.

FIG. 9 is a side view explanatory of a fifth embodiment of the sheet electrode manufacturing apparatus of the present invention. In the fifth embodiment of the sheet electrode manufacturing apparatus, a corrugation forming mechanism 87 comprises a fixed catching die 88 having a concave portion 88a and a movable pressing die 89 having a convex portion 89a, which are disposed so as to sandwich therebetween the leading section of the electrode sheet 31. These catching and pressing dies 88 and 89 form corrugations on the leading section of the electrode sheet 31 by the pressing die 89 repetitively or sequentially pressing different portions of the leading section of the sheet 31, which is being fed forward, against the fixed catching die 88 as indicated by a while arrow.

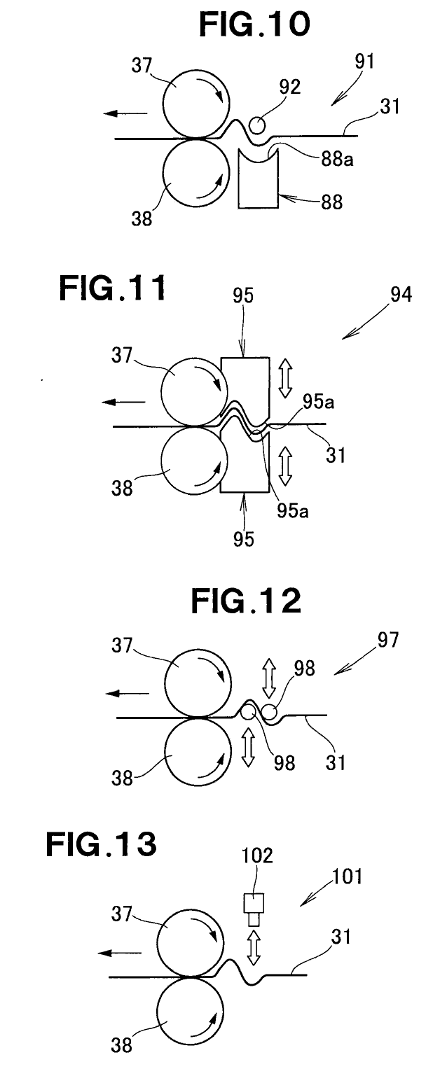

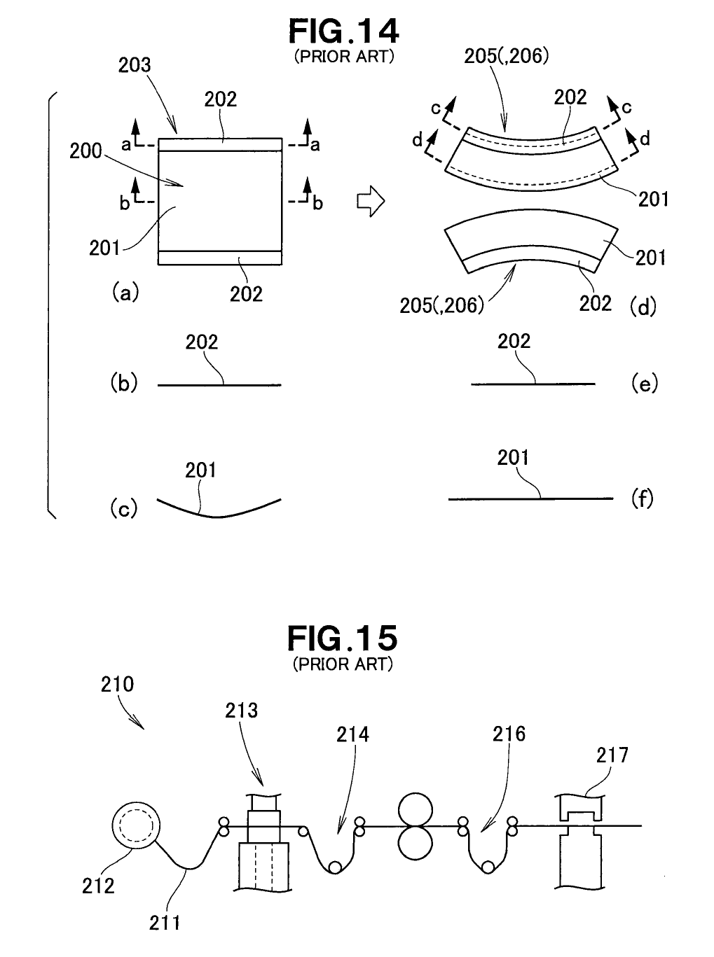

FIG. 10 is a side view explanatory of a sixth embodiment of the sheet electrode manufacturing apparatus of the present invention. In the sixth embodiment of the sheet electrode manufacturing apparatus, a corrugation forming mechanism 91 comprises a fixed catching die 88 having a concave portion 88a and a movable pressing die 92 in the form of a round bar, which are disposed so as to sandwich therebetween the leading section of the electrode sheet 31. These catching and pressing dies 88 and 92 form corrugations on the leading section of the electrode sheet 31 by the pressing die 92 sequentially pressing different portions of the leading section of the sheet 31, which is being fed forward, against the fixed catching die 88.

FIG. 11 is a side view explanatory of a seventh embodiment of the sheet electrode manufacturing apparatus of the present invention. In the seventh embodiment of the sheet electrode manufacturing apparatus, a corrugation forming mechanism 94 comprises a pair of guide members 95 that are disposed so as to sandwich therebetween the leading section of the electrode sheet 31. Opposed end surfaces of the guide members 95 have complementary wavy shapes 95a. These guide members 95 are repetitively moved toward each other to sandwich therebetween the leading section of the electrode sheet 31 being fed forward and then moved away from each other (and hence from the leading section of the electrode sheet 31), in a synchronized fashion.

FIG. 12 is a side view explanatory of an eighth embodiment of the sheet electrode manufacturing apparatus of the present invention. In the eighth embodiment of the sheet electrode manufacturing apparatus, a corrugation forming mechanism 97 comprises a pair of round bars 98 that are arranged along the feeding direction of the electrode sheet 31. These round bars 98 are repetitively moved toward each other to sandwich therebetween the leading section of the electrode sheet 31 being fed forward and then moved away from each other (and hence from the leading section of the electrode sheet 31), in a synchronized fashion.

FIG. 13 is a side view explanatory of a ninth embodiment of the sheet electrode manufacturing apparatus of the present invention. In the ninth embodiment of the sheet electrode manufacturing apparatus, a corrugation forming mechanism 101 comprises a vibrating device 102 that, for example, applies ultrasonic waves to the leading section of the electrode sheet 31, prior to the roll-pressing by the roll-pressing rollers 37 and 38, to vibrate the sheet's leading section to thereby form corrugations on the leading section.

As set forth above in relation to FIGS. 7-13, the present invention is characterized to plastically deform the coated portions 11b (see FIG. 5a) and 12b (see FIG. 3) by means of the corrugation forming mechanism 81, 84, 87, 91, 94, 97 or 101, to thereby form corrugations on the leading section of the electrode sheet 31; thus, the corrugations can be formed with an increased accuracy and ease.

It should be appreciated that, although the battery 10 has been shown and described as a roll-type battery, the present invention is not so limited and the battery 10 may be a rectangular-type or lamination-type.

The battery manufacturing method and apparatus of the present invention are well suited for use in manufacturing of lithium ion batteries.

Obviously, various minor changes and modifications of the present invention are possible in light of the above teaching. It is therefore to be understood that within the scope of the appended claims the invention may be practiced otherwise than as specifically described.

What is claimed is:

1. A method for manufacturing a battery including positive and negative sheet electrodes formed from positive and negative electrode sheets each having active-material-coated portions on opposite surfaces, except for opposite surfaces of one side edge portion, of the electrode sheet and non-active-material-coated portions on the opposite surfaces of the one side edge portion of the electrode sheet, said method comprising:
a step of forming a succession of corrugations on each of the positive and negative electrode sheets, having the active-material-coated portions provided thereon, in a longitudinal direction of the electrode sheet;
a step of roll-pressing each of the positive and negative electrode sheets having the succession of corrugations formed thereon;
a step of constructing an electrode assembly of the positive and negative sheet electrodes, formed from the roll-pressed positive and negative electrode sheets respectively, with a separator interposed therebetween;
a step of connecting positive and negative current collectors to the non-active-material-coated portions of the positive and negative sheet electrodes, respectively, exposed on ends of the electrode assembly; and
a step of enclosing the electrode assembly and the positive and negative current collectors in a case together with battery electrolyte.

2. The method of claim 1, wherein said step of forming a succession of corrugations forms the corrugations on each of the positive and negative electrode sheets by imparting tension to portions of the electrode sheet located upstream and downstream of roll-pressing rollers when the electrode sheet is to be roll-pressed via the rollers.

3. The method of claim 1, wherein said step of forming a succession of corrugations forms the corrugations on each of the positive and negative electrode sheets by plastically deforming the active-material-coated portions of the electrode sheet.

4. The method of claim 1, wherein said step of forming a succession of corrugations forms the corrugations on each of the positive and negative electrode sheets after heating the active-material-coated portions of the electrode sheet.

5. An apparatus for manufacturing a battery including positive and negative sheet electrodes formed from positive and negative electrode sheets each having active-material-coated portions on opposite surfaces, except for opposite surfaces of one side edge portion, of the electrode sheet and non-active-material-coated portions on the opposite surfaces of the one side edge portion of the electrode sheet, said apparatus comprising:
means for forming a succession of corrugations on each of the positive and negative electrode sheets, having the active-material-coated portions provided thereon, in a longitudinal direction of the electrode sheet; and
means for roll-pressing each of the positive and negative electrode sheets having the corrugations formed thereon,
an electrode assembly being constructed of the positive and negative sheet electrodes with a separator interposed therebetween, the electrode assembly and the positive and negative current collectors, connected to the non-active-material-coated portions of the positive and negative sheet electrodes exposed on opposite ends of the electrode assembly, being enclosed in a case together with battery electrolyte.

6. The apparatus of claim 5, wherein said means forming a succession of corrugation comprises means for forming the corrugations on each of the positive and negative electrode sheets by imparting tension to portions of the electrode sheet located upstream and downstream of roll-pressing rollers when the electrode sheet is to be roll-pressed via the rollers.

7. The apparatus of claim 5, wherein said means for forming a succession of corrugations comprises means for forming the corrugations on each of the positive and negative electrode sheets by plastically deforming the active-material-coated portions of the electrode sheet.

8. The apparatus of claim 5, wherein said means for forming a succession of corrugations forms the corrugations on each of the positive and negative electrode sheets after heating the active-material-coated portions of the electrode sheet.
